(19) United States
(12) Patent Application Publication
(10) Pub. No.: US 2009/0021790 A1
(43) Pub. Date: Jan. 22, 2009

(54) User-controlled print friendly page

(75) Inventors: David Krovitz, Calabasas, CA (US); Agnes Liu, Los Angeles, CA (US)

Correspondence Address: YAHOO C/O MOFO PALO ALTO, 755 PAGE MILL ROAD, PALO ALTO, CA, 94304, US

(73) Assignee: Yahoo! Inc., Sunnyvale, CA (US)

(21) Appl. No.: 11/880,255

(22) Filed: Jul. 20, 2007

(51) Int. Cl. G06K 1/00

(52) U.S. Cl. 358/1.18

(57) ABSTRACT

An interface for viewing and/or printing a web page according to user-control of the content is provided. In one example, an interface includes at least one user-selectable option for displaying content from a web page, the web page including at least two content types, and displaying the web page according to at least one user-selectable option. The interface may include a selection interface having the at least one user-selectable option, which may include check boxes or other selectable features such as sliders, radio buttons, or drop-down menus; alternatively, a user-selectable option may be viewable during a hover or roll-over state of displayed content. The content types may include text, images, videos, advertisements, comments, and so on, which may adjust in real-time in response to a change in the user-selectable option. The interface may further include a print button for initiating a function for printing the displayed content according to the user-selected options.

### FIELD

The present invention relates generally to systems and methods associated with user interfaces for selectively viewing and printing content, and in one example, to a user-controlled web page for customizing a web page for viewing and printing selected content.

### RELATED ART

The Internet and other networks interconnect computers and computing devices to allow for easy transport of data over network connections. Commonly, computers and computing devices are organized using well-known client-server models, wherein network connections are established between some computers or computing devices that act as servers and some computers or computing devices that act as clients. An example of a server is a web server and an example of a client is a web client such as a personal computer device running a web browser program. Generally, a web client operates according to the interface to issue requests to web servers, using well-known (or other suitable) protocols. In response to requests received, web servers return data responses. In a typical web client-server interaction, HTTP protocol is used, wherein the web client issues a request directed at a particular web server address for a page represented by a URL in the request and a server responsive to the particular web server address responds with data that may be a page to be displayed or other data set. Generally, regardless of the actual data being requested and returned, the data returned is referred to as a web page.

Web pages generally include many different content types such as text, still or moving images, advertisements, comments, and so on. For example, a news article may include text, an associated image or video file, and be displayed in a web page with various other content such as advertisements. Often when a user attempts to print a web page the browser renders the page incomplete; for example, content such as text or images are cut-off or missing from the printed page.

### BRIEF SUMMARY

According to some aspects of the present invention provided herein, interfaces, systems, and methods are provided for viewing and printing a web page via a template or print friendly page that allows, e.g., a user to select printing options and/or adjusting view page contents in real-time.

In one aspect and example, an interface is described for viewing and printing a webpage, the interface including at least one user-selectable option for displaying content from a web page, the web page including at least two content types, and a display for displaying the web page according to the at least one user-selectable option. The interface may include a selection interface having the at least one user-selectable option, which may include check boxes or other selectable features such as sliders, radio buttons, or drop-down menus. In other examples, the at least one user-selectable option may be included with a drop-down menu associated with the displayed content or viewable during a hover or roll-over state of the displayed content.

The content types may include various content types such as text, images, videos, advertisements, comments, and so on. The display of the content may adjust in real-time in response to a change in the at least one user-selectable option. The interface may further include a print button for initiating a function for printing the displayed content according to the user-selected options.

In another example, an interface includes a display for displaying multiple content types, wherein each of the multiple content types is separately selectable for removal from the display. The interface may further include, within a selection interface or associated with the content, one or more check boxes, radio button, drop-down menus, or other user-selectable options for determining the content for display.

In another aspect, apparatus is provided for causing the display of a user-controllable print interface. In one example the apparatus includes logic for causing the display of a web page, the web page displaying at least two types of content, wherein at least one of the content types is user-selectable for removal from the display, and logic for changing the display of the web page in response to user selections.

In another aspect of the present invention, a method is provided for viewing a web page. In one example, the method includes displaying a web page having at least two types of content, wherein at least one of the content types is user-selectable for removal from the display, and changing the display of the web page in response to user selections.

According to another aspect of the present invention, a computer-readable medium encoded with computer program instructions for viewing web pages is provided. In one example, the computer program instructions include program code for causing the display of a web page having at least two types of content, wherein at least one of the content types is user-selectable for removal from the display, and program code for causing a change in the display of the web page in response to user selections.

The various aspects and examples of the present inventions are better understood upon consideration of the detailed description below in conjunction with the accompanying drawings and claims.

### BRIEF DESCRIPTION OF THE DRAWINGS

FIG. 1 illustrates an exemplary environment in which some aspects and examples described herein are used;

FIGS. 2A-2C illustrate an exemplary interface having different content types selected according to one example;

FIGS. 3A-3E illustrate another exemplary interface having different content types selected according to another example;

FIG. 4 illustrates an exemplary method for displaying and printing a web page according to one example; and

FIG. 5 illustrates an exemplary computing system that may be employed to implement processing functionality for various aspects of the invention.

### DETAILED DESCRIPTION

The following description is presented to enable a person of ordinary skill in the art to make and use the inventions. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the inventions. Thus, the present inventions are not intended to be limited to the examples described herein and shown, but are to be accorded the scope consistent with the claims.

In one aspect and example described herein, an interface, e.g., a displayed web page within a browser of a client device, allows a user the ability to customize a viewable and/or printable view of a web page. The user may select (or deselect) various content portions of a web page for viewing and printing. For example, a web page may include an article having text, images, advertisement and user-generated comments and a user may control some or all of the presentation of information in the web page for viewing and/or printing. In one example, the interface includes selectable options (e.g., via an interface, drop-down menu, roll-over/hover states, etc.) that allow a user the ability to include or exclude content, the displayed content adjusting in real-time accordingly. For example, unchecking or deselecting advertisements results in the advertisements being removed from the displayed page in real-time. Such instant, real-time control may make printing decisions easier, and may further enhance user consumption by allowing the user the ability to customize a page, e.g., to “turn off” advertising, comments, images, and/or text. When the user is satisfied with the presentation of the content, the user may select a button to print the web page (or merely view the content according to the selections).

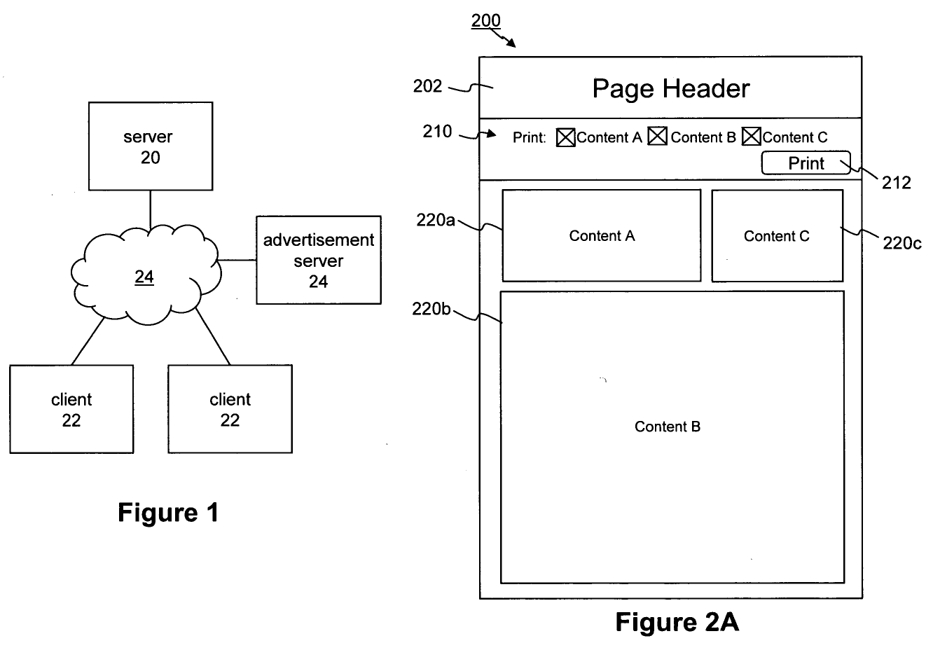

Initially, and with reference to FIG. 1, an exemplary environment in which certain aspects and examples of the user interface, apparatus, and methods described may operate. Generally, one or more clients 22 may access a server 20, which includes logic for causing the display of web page or interface as described for allowing a user to select content for viewing and/or printing. Server 20 and clients 22 may include any one of various types of computer devices, having, e.g., a processing unit, a memory (which may include logic or software for carrying out some or all of the functions described herein), and a communication interface, as well as other conventional computer components (e.g., input device, such as a keyboard/keypad and/or mouse, output device, such as display). For example, client 22 may include a desktop computer, laptop computer, mobile device such as a mobile phone, web-enabled phone, smart phone, television, television set-top box, and the like.

Clients 22 and server 20 may communicate, e.g., using suitable communication interfaces via a network 24, such as the Internet. Clients 22 and server 20 may communicate, in part or in whole, via wireless or hardwired communications, such as Ethernet, IEEE 802.11b wireless, or the like. Additionally, communication between clients 22 and server 20 may include or communicate with various servers such as a mail server, mobile server, media server, and the like.

Server 20 generally includes logic (e.g., http web server logic) or is programmed to format data, accessed from local or remote databases or other sources of data and content, for presentation to users of clients 22, preferably in the format described herein. For example, server 20 may format data and/or access a local or remote database to communicate and cause the display of an interface to clients 22, data related to objects for display within or associated with an interface (which may include, e.g., a “print” selection, selection interfaces, print templates for user selection of content, and so on), links to additional information and/or content related to the web page or displayed contents, and the like.

To this end, server 20 may utilize various web data interface techniques such as Common Gateway Interface (CGI) protocol and associated applications (or “scripts”), Java® “servlets”, i.e., Java® applications running on a web server, or the like to present information and receive input from clients 22. The server 20, although described herein in the singular, may actually comprise plural computers, devices, databases, associated backends, and the like, communicating (wired and/or wireless) and cooperating to perform some or all of the functions described herein. Server 20 may further include or communicate with account servers (e.g., email servers), mobile servers, photo servers, video servers, and the like. For example, a displayed tile may be associated with additional content accessible via a server remote to the server associated with the displayed interface.

Further, web pages communicated to client 22 may include various text and media objects such as articles, documents, photos, audio files, video files, and the like. Additionally, the content may include selections or links to further content accessible by the interface and associated user device, e.g., via Application Programming Interfaces (APIs), web pages, and the like stored or accessed locally or remotely. Content accessible by client 22 via a presented web page may conform to any suitable data format including various media formats such as, e.g., still image (e.g., JPEG, TIFF), video (e.g., MPEG, AVI, Flash), or audio (e.g., MP3, OGG).

Additionally, FIG. 1 illustrates an advertisement server 24, which may communicate with server 20, one or more client 22, or combinations thereof. In one example, advertisement server 24 operates to associate advertisements with user-generated actions (e.g., user entered searches or selections) or user profiles. Server 20 may transmit or cause the display of the advertisement data with a displayed interface or web page to client 22, in one example, within a header or footer of the displayed page, and in another example, within a display window of the interface. In other examples, advertisement server 24 may send the advertisement data directly to client device 22 based on information from server 20 (e.g., based on client activity or client id/profile), client 22 (based on an identification of client 22), or the like.

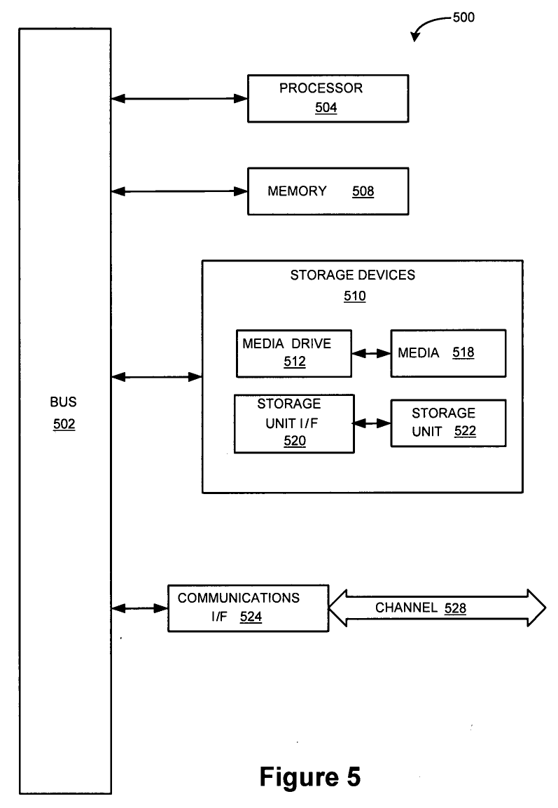

It should be noted that although the exemplary methods and systems described herein describe the use of a separate server and database for performing various functions, other embodiments could be implemented by storing the software or programming that operates to cause the described functions on a single device or any combination of multiple devices as a matter of design choice so long as the functionality described herein is performed. Although not depicted in the figures, server 20 generally includes such art recognized components as are ordinarily found in server systems, including but not limited to processors, RAM, ROM, clocks, hardware drivers, associated storage, and the like (see, e.g., FIG. 5, discussed below). Further, the described functions and logic may be included in software, hardware, firmware, or combination thereof.

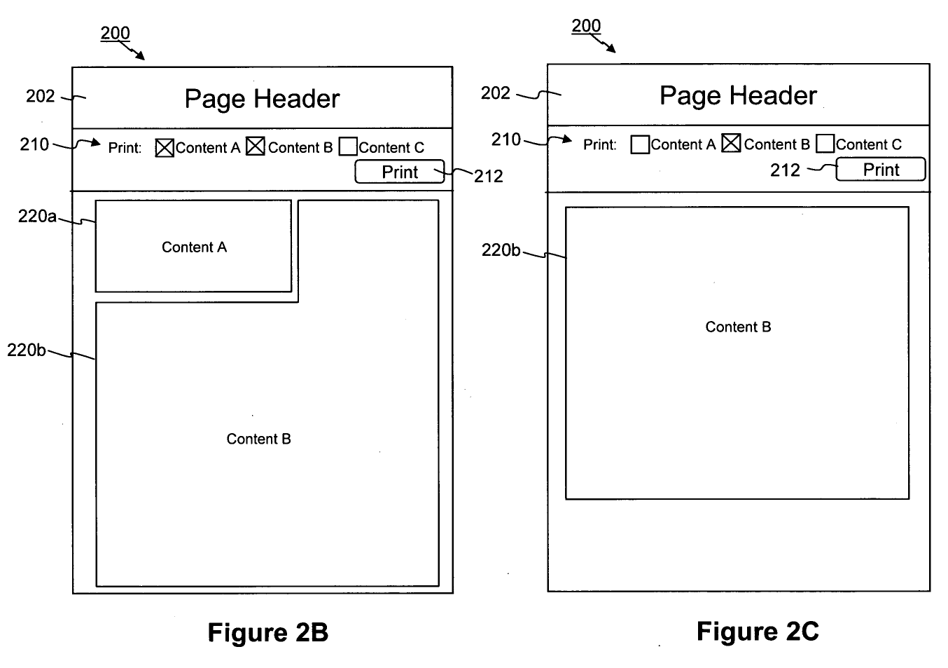

FIGS. 2A-2C illustrate an exemplary interface 200 for displaying and/or selectively printing content from a web page. With reference initially to FIG. 2A, interface 200 includes multiple selectable content types 220a-220c displayed therein, where each content type 220a-220c is separately selectable via a user-selectable option to be included or removed from the page. Each content type may be associated with one or more content types such text, photos, videos, audio, advertising, polls, user comments, combinations thereof, and any other content suitably displayed or accessed via a web page.

In this example, content types 220a-220c are selected for display via a selection interface 210 having check boxes for selecting content types 220a-220c for display. As illustrated in FIGS. 2A-2C, as different content types are unselected in interface 210 they are no longer displayed within interface 200. In particular, FIG. 2B illustrates interface 200 with selections made via selection interface 210 of content A and content B, but not content C, which results in content types 220a and 220b being displayed in interface 200. In one example, the change in selected content types via selection interface 210 results in a real-time change in the display of content types 220a-220c. Accordingly, a user may make selections to display only those content types they wish to view and/or print (e.g., by selecting the print button 212), and view the content and layout of the page in real-time.

Selection interface 210 may be displayed within interface 210 at all times, when selectable content types are displayed, or in response to a selection by a user to print the page. Additionally, selection interface 210 may be included within interface 210 as shown, as a separate window from interface 210, with a toolbar, a widget, in response to a hover operation, or the like. Selection interface 210 may be included with a standard web page, e.g., as part of a header or footer, or in response to a user selecting a print or print preview option.

In another example, individual content types 220a-220c may be selected or deselected via a user-selectable option by positioning a pointer (e.g., an arrow, hand, or other graphic associated with a user device) over the desired content type 220a-220c and selecting, e.g., by clicking a mouse and opening a drop-down menu. As such, selection interface 210 may not be included in some examples. It will be recognized that other methods, e.g., via keystrokes or other suitable input devices, may be used to highlight or select one of the displayed content types 220a-220c for removal and/or addition. Further, some content types may be subdivided and one or more subdivisions selectable. For example, a content type including a plurality of images may allow for individual images to be deselected from view and printing.

Further, as illustrated, content type 220a-220c may be altered in appearance or layout in response to selections of content; for example, content type 220b (including, e.g., text) may adjust to fill the page around content type 220a when content type 220c is removed. Thus, content types 220a-220c may be automatically configured and sized based on various factors including the selected content types, user settings/profiles, a display of a user device, e.g., resolution and/or size of a display, and so on.

Further, it will be recognized that a server system may store and cause the display of the described interface 200 and content types 220a-c in a variety of fashions using well known methods and systems. For example, a server system and/or associated database may store or access necessary data and files for causing the display of each of the described content types. Further, the server may store or access the content for generating the interface and display of content types as well as desired applications/scripts associated with content. In one example, a cookie may be stored with the client for storing data to indicate a previous or default selection of content types for display (additionally or alternatively such data may be kept in session).

In one example, interface 200, whether as a stand alone interface or an element of a larger interface or web browser page, may be accessible by a user via an online account such as an email account. For example, a user may login to an account server, and interface 200 may be included in or launched from a “home” page or otherwise associated with a user login or user id (e.g., via machine id, stored cookie, and so on). As such, interface 200 may be customizable, e.g., in terms of the appearance of the array of content types, default content selections for the printable view, and so on. Further, interface 200 may include or be part of one or more widgets. In these and other fashions, an individual user may access interface 200 from multiple client devices; for example, interface 200 may be served from a computer server to a user accessing the server from various devices such as a personal computer, work computer, mobile computer device such as a phone, and the like. In other examples, of course, interface 200 may be included as an application program running on a computer device to alter a received web page as described.

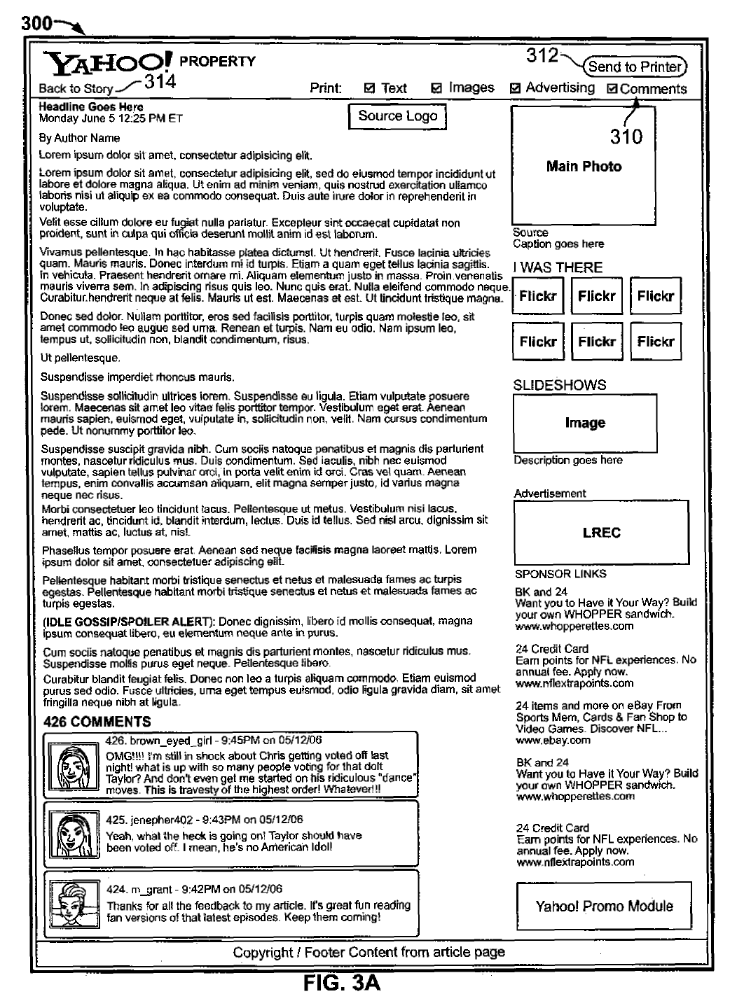

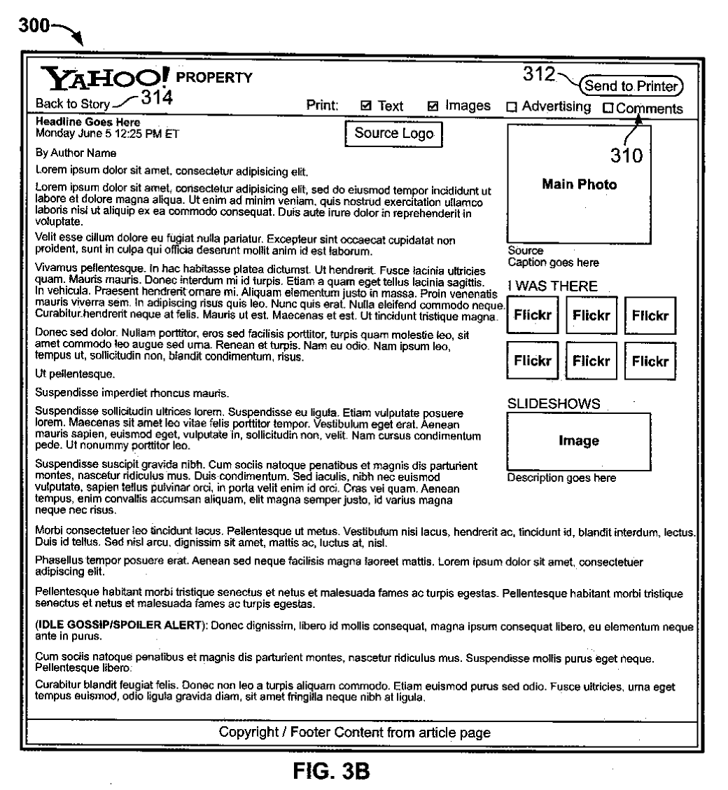

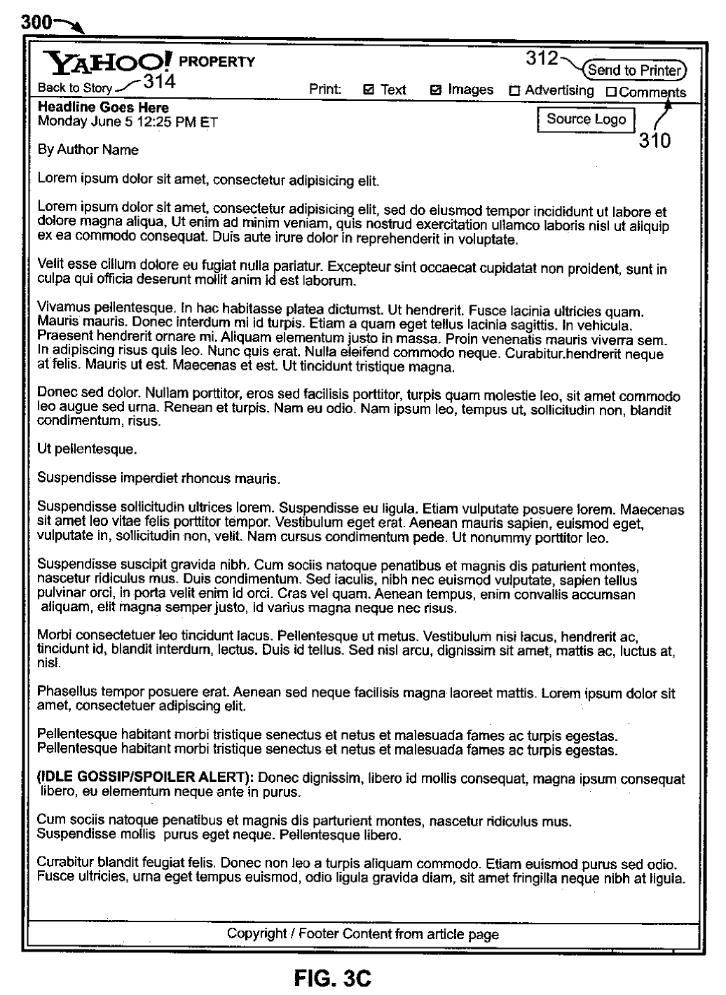

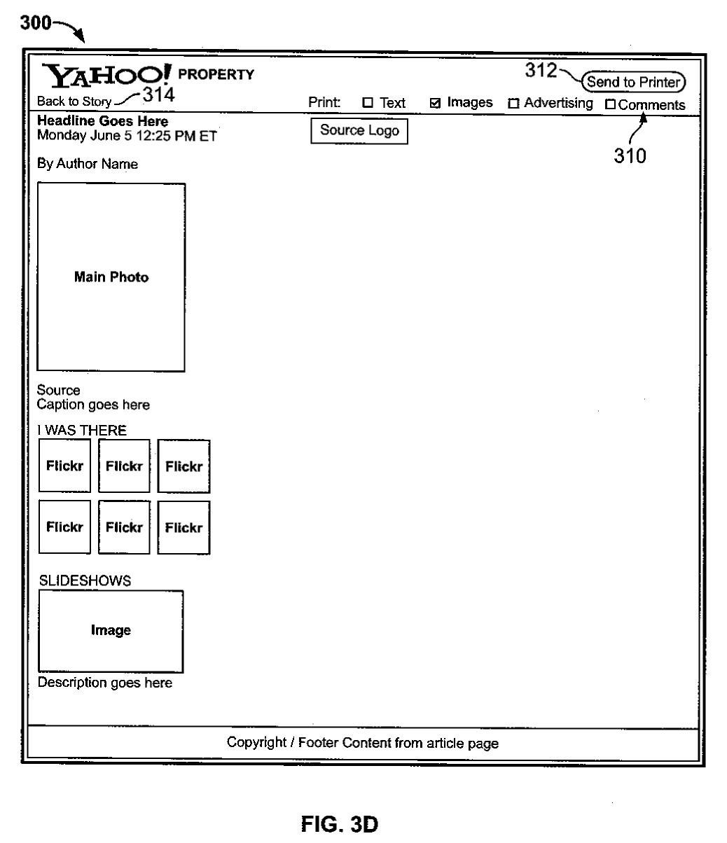

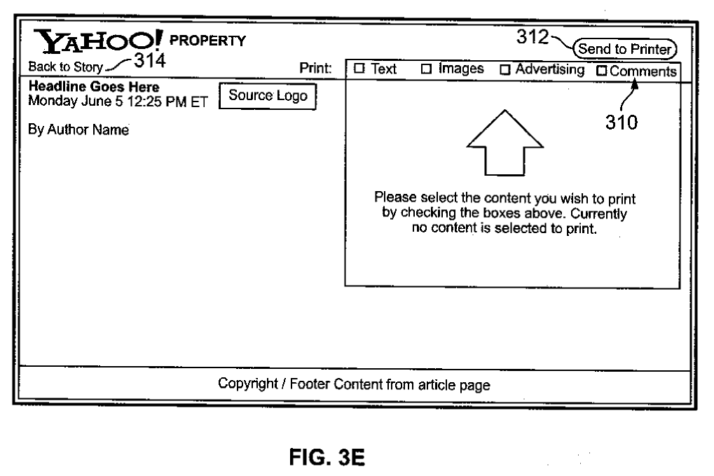

FIGS. 3A-3E illustrates another exemplary interface 300, shown as a web page having different content types selected for display and/or printing. Similar to interface 200 described previously, interface 300 includes a selection interface 310 for selecting content to display and/or print within interface 300. Selection interface 300 may be displayed by default within the particular web page (e.g., displayed by default or when a user selects a link or page that is enabled for selective printing) or may be displayed in response to user input (e.g., inputting a print command, print preview command, or the like).

In one example, where interface 300 is displayed as a print preview for selecting the desired content, the interface may include a back link 314 for returning to the original content (e.g., the original web page). Further, in response to selection of the print button 312, print functionality may be launched and interface 300 returned to the original content or closed.

Selection interface 310, and displayed check boxes, allow a user the ability to customize their printable view; checking and un-checking boxes affecting the displayed presentation in real time. In one example, all boxes are checked by default when initially displaying the printable view; however, in other examples, only certain content types, e.g., text, could be checked by default. In one example, the “Text” in selection interface 310 refers to the text of an article body, with included images associated with “Images.” The selection “Images” may further refer to slideshows and other related images displayed with the particular page, e.g., associated image from a photo or video site such as Flickr®; alternatively, such other content may be separately selectable.

“Advertising” may refer to any associated advertisements, sponsored advertisements, promotions, and the like. For example, advertisements may include third party advertisements or advertisements associated with the provider of the content or web page. Further, in some examples, a page may include comments from users associated with the content or web page. In such instances where comments are associated therewith, selection interface 310 may include a selection “Comments” for removing them from view.

It should be noted that various other content types are possible and may be separately selectable via selection interface 310 (or alternatively, included or grouped with one of the above mentioned content types). Further, in some examples, a service provider may not allow a user to remove (or at least impose restrictions on the removal of) certain content types such as sponsored advertisements or promotions.

In examples where content is paginated in its original view, e.g., an article may span several linked web pages, interface 300 may display the entire content or the article within one page. In other examples, interface 300 may be paginated similar to the original content. Further, in examples having multiple images spread over more than one page, the images may be displayed in one grouping within interface 300, e.g., in the order in which they appear in the original content.

As described previously, in some examples where multiple images are displayed in interface 300, individual images may be removed from display and printing. For example, each image may include a rollover/hover state, whereby a user may select to remove the image. When an image is removed the layout may adjust (filling in the space of the removed image) accordingly. Other content types that may be divided, e.g., advertisements, video files, etc. may also be separately selectable by a user.

In one example, the content displayed within interface 300 for printing is not clickable (e.g., nothing links off the page). For example, images and slideshows may be displayed for viewing and printing but not selectable to access higher resolution versions or additional content as they might be with the original content display. In other examples, however, clickable content may be included, whereby a user may link to additional content within interface 300 or a separate window. In particular, the advertisements, sponsored links, and promotions may remain clickable to access additional content.

In one example, some elements displayed in interface 300 in the printable view do not print. For example, back button 314, print button 312, and/or selection interface 310 may be configured to not print. Additionally, in other examples, additional elements such as the header or footer may be configured to not print although viewable in a print preview display.

Various rules may be used to determine the layout of the content for the printable view, e.g., always having text at the top and aligned to the left with photos aligned along the right. The rules for the layout may be controlled by one or more of the service provider, the user, the content provider, combinations thereof, and the like.

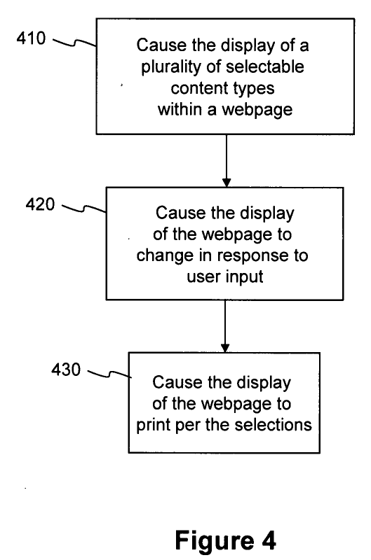

FIG. 4 illustrates an exemplary computer implemented method for causing the display of an interface for selecting content types for viewing and/or printing. For example, the method may be carried out by a server device (e.g., a web server) via a presented web page to a client device. Alternatively, the method may be carried out by the client device or a combination of the client device and server device. Initially, the method includes causing the display of a plurality of selectable content types at 410 within an interface, e.g., within a web page. The content types may be displayed as described herein, and may be included within a served web page that may contain other features such as a page header, advertisement information, and the like (which may be selectable content types). The interface may be displayed by default within a browser or in response to a user selection to print or view a print preview. Further, the arrangement of content types displayed may be controlled by the server or client device.

The method further includes causing the display of content types to change in response to selections of content types at 420. For example, a page may initially be displayed with all content types displayed, and in response to user input the display may change in real-time according to the selections. In one example, the selections are made through a content selection interface; however, other suitable methods for selecting content for display and/or printing are contemplated (e.g., via selections during a roll-over/hover state, drop-down menus, and the like).

The method further includes causing the display of the selected content types to be printed at 430. For example, the page may include a button selectable by a user to cause or initiate the web page or browser to launch a printing function at the client device or location. In this manner the page may be printed according to user selections. In other examples, a user may merely desire to view a web page according to user selections of content without actually printing.

FIG. 5 illustrates an exemplary computing system 500 that may be employed to implement processing functionality for various aspects of the invention (e.g., as a server device or system, a client device, mobile device, memory device, and so on). Those skilled in the relevant art will also recognize how to implement the invention using other computer systems or architectures. Computing system 500 may represent, for example, a desktop, mainframe, server, memory device, mobile client device, or any other type of special or general purpose computing device as may be desirable or appropriate for a given application or environment. Computing system 500 can include one or more processors, such as a processor 504. Processor 504 can be implemented using a general or special purpose processing engine such as, for example, a microprocessor, microcontroller or other control logic. In this example, processor 504 is connected to a bus 502 or other communication medium.

Computing system 500 can also include a main memory 508, for example random access memory (RAM) or other dynamic memory, for storing information and instructions to be executed by processor 504. Main memory 508 also may be used for storing temporary variables or other intermediate information during execution of instructions to be executed by processor 504. Computing system 500 may likewise include a read only memory (“ROM”) or other static storage device coupled to bus 502 for storing static information and instructions for processor 504.

The computing system 500 may also include information storage mechanism 510, which may include, for example, a media drive 512 and a removable storage interface 520. The media drive 512 may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media 518 may include, for example, a hard disk, floppy disk, magnetic tape, optical disk, CD or DVD, or other fixed or removable medium that is read by and written to by media drive 514. As these examples illustrate, the storage media 518 may include a computer-readable storage medium having stored therein particular computer software or data.

In alternative embodiments, information storage mechanism 510 may include other similar instrumentalities for allowing computer programs or other instructions or data to be loaded into computing system 500. Such instrumentalities may include, for example, a removable storage unit 522 and an interface 520, such as a program cartridge and cartridge interface, a removable memory (for example, a flash memory or other removable memory module) and memory slot, and other removable storage units 522 and interfaces 520 that allow software and data to be transferred from the removable storage unit 518 to computing system 500.

Computing system 500 can also include a communications interface 524. Communications interface 524 can be used to allow software and data to be transferred between computing system 500 and external devices. Examples of communications interface 524 can include a modem, a network interface (such as an Ethernet or other NIC card), a communications port (such as for example, a USB port), a PCMCIA slot and card, etc. Software and data transferred via communications interface 524 are in the form of signals which can be electronic, electromagnetic, optical, or other signals capable of being received by communications interface 524. These signals are provided to communications interface 524 via a channel 528. This channel 528 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms “computer program product” and “computer-readable medium” may be used generally to refer to media such as, for example, memory 508, storage device 518, or storage unit 522. These and other forms of computer-readable media may be involved in providing one or more sequences of one or more instructions to processor 504 for execution. Such instructions, generally referred to as “computer program code” (which may be grouped in the form of computer programs or other groupings), when executed, enable the computing system 500 to perform features or functions of embodiments of the present invention.

In an embodiment where the elements are implemented using software, the software may be stored in a computer-readable medium and loaded into computing system 500 using, for example, removable storage drive 514, drive 512 or communications interface 524. The control logic (in this example, software instructions or computer program code), when executed by the processor 504, causes the processor 504 to perform the functions of the invention as described herein.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention. Moreover, aspects of the invention describe in connection with an embodiment may stand alone as an invention.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

Moreover, it will be appreciated that various modifications and alterations may be made by those skilled in the art without departing from the spirit and scope of the invention. The invention is not to be limited by the foregoing illustrative details, but is to be defined according to the claims.

1. An interface for viewing and printing content in a browser environment, the interface comprising:
at least one user-selectable option for displaying content from a web page, the web page including at least two content types; and
a display for displaying the web page according to the at least one user-selectable option.

2. The interface of claim 1, further comprising a selection interface having the at least one user-selectable option.

3. The interface of claim 1, further comprising at least one drop-down menu having the at least one user-selectable option.

4. The interface of claim 1, wherein the at least one user-selectable option is selectable during a hover state of the displayed content.

5. The interface of claim 1, further comprising a print selection for initiating a printing function for printing the displayed content according to the user-selectable option.

6-7. (canceled)

8. The interface of claim 1, wherein the content displayed adjusts in real-time in response to a change in the at least one user-selectable option.

9. An interface for viewing and printing content in a browser environment, the interface comprising:
a display for displaying multiple content types, wherein each of the multiple content types are separately selectable for removal from the display.

10-11. (canceled)

12. The interface of claim 9, wherein a content type may be removed during a hover state of the displayed content

13. The interface of claim 9, further comprising a print selection for initiating a printing function for printing the displayed content according to the display.

14. (canceled)

15. The interface of claim 9, wherein the content displayed adjusts in real-time in response to a user selection.

16. Apparatus for causing the display of a user-controlled viewing interface, the apparatus comprising:
logic for causing the display of a web page, the web page displaying at least two types of content, wherein at least one of the content types is user-selectable for removal from the display; and
logic for changing the display of the web page in response to a user selection.

17-19. (canceled)

20. The apparatus of claim 16, further comprising logic for initiating a print function for printing the displayed content.

21. The apparatus of claim 16, wherein the content types comprise text, images, and advertisements.

22. The apparatus of claim 16, further comprising logic for causing the displayed content to adjust in real-time in response to a user selection.

23. A method for viewing a web page, the method comprising the acts of:
displaying a web page having at least two types of content, wherein at least one of the content types is user-selectable for removal from the display; and
changing the display of the web page in response to a user selection.

24. The method of claim 23, further comprising causing the display of a selection interface having at least one user-selectable option for selectable removing content types.

25. The method of claim 23, further comprising logic for causing the display of at least one drop-down menu for selectable removing content types.

26. The method of claim 23, wherein a content type may be removed during a hover state of the displayed content.

27. The method of claim 23, further comprising initiating a print function for printing the displayed content according to the user-selected options.

28. (canceled)

29. The method of claim 23, further comprising causing the displayed content to adjust in real-time in response to a user selection.

30. A computer-readable medium encoded with computer program instructions for viewing web pages, the computer program instructions comprising:
program code for causing the display of a web page having at least two types of content, wherein at least one of the content types is user-selectable for removal from the display; and
program code for causing a change in the display of the web page in response to a user selection.

31. The computer program product of claim 30, further comprising program code for causing the display of a selection interface having at least one user-selectable option for selectable removing content types.

32. The computer program product of claim 30, further comprising program code for causing the display of at least one drop-down menu for selectably removing content types.

33. (canceled)

34. The computer program product of claim 30, further comprising program code for initiating a print function for printing the displayed content according to the user-selected options.

35. (canceled)

36. The computer program product of claim 30, further comprising program code for causing the displayed content to adjust in real-time in response to a user selection.
